(19) United States
(12) Patent Application Publication
(10) Pub. No.: US 2005/0058423 A1
(43) Pub. Date: Mar. 17, 2005

(54) Optical device, and process for producing it

(75) Inventors: Matthias Brinkmann, Maiuz-Uastell (DE); Edgar Pawlowski, Stadeckew-Elsheim (DE); Frank Thoma, Ruesselsheim (DE); Tanja Woywod, Mainz (DE); Wolfram Beier, Essenheim (DE)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Schott Glas

(21) Appl. No.: 10/847,200

(22) Filed: May 17, 2004

(30) Foreign Application Priority Data
May 17, 2003 (DE) 103 22 350.9-51

(51) Int. Cl. G02B 6/10

(52) U.S. Cl. 385/141; 385/130

(57) ABSTRACT

A process for producing an optical device by means of ion exchange is provided. The method includes: coating at least one first region of a substrate with a coating having a first layer of exchange atoms in neutral or ionic form; removing substrate material from at least one second region that adjoins the first region; and exchanging substrate ions with exchange ions from the first layer.

### BACKGROUND OF THE INVENTION

1. Field of the Invention

The invention relates in general terms to optical devices and to the production thereof, in particular the production of optical elements by means of ion exchange.

2. Description of Related Art

Since electrical signal transmission with increasing data transmission rates is reaching its limits, optical signal transmission methods are becoming increasingly important, in particular in the field of data transfer. As part of this development, in addition to signal transfer there has also been an increasing demand for devices for optical signal processing. To satisfy this demand, the concept of integrated optics was proposed by S. E. Miller as early as 1969. Waveguides generally form the base elements for devices of this type.

To produce integrated optical devices, it is in many cases necessary to combine a plurality of waveguides within a tight space. For this purpose, the waveguides and other elements of a device of this type are retrospectively defined in a substrate, in a manner similar to that used in semiconductor optics.

In this respect, inter alia ion exchange has proven to be a suitable process. A further suitable process is the direct writing of waveguides by means of highly intensive fs or UV laser radiation.

A common feature of these processes is that to produce an optical element a change in refractive index is retrospectively produced in a region of the substrate, so that light can be guided in this region.

During the ion exchange, ions which are present in the substrate are replaced by other ions which have a different, generally higher polarizability than the ions of the substrate, in order to locally increase the refractive index, so that, for example, a waveguide is formed. Normally, sodium ions are replaced by silver, potassium, cesium or thallium ions.

The ion exchange can be thermally assisted by virtue of the substrate being heated, so that the mobility of the ions is increased, resulting in an acceleration of the diffusion process.

A further option consists in assisting the ion exchange by means of an electric field. In this field-assisted ion exchange, as it is known, a voltage is applied between two electrodes on opposite sides, with the ions which are to diffuse into the substrate being provided on the side with the positive potential, i.e. the anode. In this process, too, the substrate is generally heated in order to provide sufficient ion mobility in the substrate.

The field which is applied between the two sides of the substrate causes the positive ions of the substrate that are to be exchanged then to migrate toward the cathode and the exchange ions to migrate in the same direction from the anode into the substrate, with the mobile ions functioning as current charge carriers between the two electrodes. The electrodes used in this case are both liquid salt melts or electrolytes, and also metallic layers.

The diffusion of the ions in the substrate, however, does not provide a sharp or readily definable refractive index profile. The result of this is that the waveguides produced by the ion exchange process have a relatively high attenuation. In particular, high losses are encountered if the waveguides do not run purely in a straight line, but rather also include curves. However, such curves can scarcely be avoided in integrated optical devices, such as for example a Mach Zehnder interferometer. The losses are also caused by the fact that ion exchange can only be used to build up relatively slight differences in refractive index, and consequently light-guiding structures produced by ion exchange have only a small numerical aperture.

### BRIEF SUMMARY OF THE INVENTION

The invention is therefore based on the object of providing optical structures in a substrate with improved attenuation properties by ion exchange.

This object is achieved, in an amazingly simple way, by a process as described in claim 1 and an optical device as described in claim 22. Advantageous configurations and refinements form the subject matter of the respective subclaims.

Accordingly, the process according to the invention for producing an optical device by means of ion exchange comprises the steps of:

coating at least one first region of a substrate with a first layer which includes exchange atoms in neutral or ionic form,

removing substrate material from at least one second region that adjoins the first region,

exchanging substrate ions with exchange ions from the first layer.

The at least one first region is preferably selected or defined in such a way that it corresponds to the shape of an optical element which is to be formed. By way of example, the first region may be elongate in shape, so that an elevated section of the optical device comprises at least one waveguide.

An optical device producible by this process of the invention accordingly comprises:

a substrate,

at least one first region on one side of the substrate, and

at least one second region that adjoins the first region, the first region being elevated with respect to the second region, so that the substrate has a protruding section in the first region. In this case, ions of the substrate are then at least partially exchanged in the protruding section.

An optical device of this type, which as light-guiding structure has a section of the substrate which is raised with respect to adjacent regions, has the benefit compared to known devices produced by ion exchange that the structure has interfaces with the surrounding medium which are perpendicular or at least inclined with respect to the adjacent substrate surface. Accordingly, a high difference in refractive index is achieved in a direction along the substrate surface, with the result that structures of this type produced in accordance with the invention have a greatly reduced attenuation at bends or corners running along the surface.

According to one preferred embodiment of the optical device, the ions are exchanged in such a way that the refractive index of the protruding section is higher than the refractive index of the remainder of the substrate.

The removal of substrate material from the vicinity of the first region causes regions which adjoin the surface of the first region that has been covered with the first layer to be recessed. As a result, a relief-like structure is created, the raised parts of which are coated with the first layer. For many applications of the devices produced in accordance with the invention, it is appropriate to remove substrate material with a thickness in the range of 0.2 μm to 50 μm, preferably from 1 μm to 15 μm. As a result, the first region is accordingly 0.2 μm to 50 μm, preferably from 1 μm to 15 μm, higher than an adjacent region on the substrate.

When the ion exchange process is carried out, the exchange ions initially cannot diffuse laterally with respect to the main diffusion direction within the raised first region, since in this region they meet the material surface. Moreover, the raised structure creates sharp, well-defined interfaces for the light which is to be guided, these interfaces having a greatly reduced attenuation compared to light-guiding structures produced by ion exchange in a conventional way. This is true in particular if the structures have a bend along the surface.

If the exchange ions penetrate further, so that they have passed through the raised structure, it is true that they can then diffuse laterally into the material beneath the surface of the second region that adjoins the first region, but on account of the diffusion directions which are then additionally available, this leads to considerable dilution of the exchange ions. As a result, a strong concentration gradient of the exchange ion concentration is achieved here in the substrate, and consequently the optical element is also terminated by a relatively well defined interface in the substrate itself.

According to a preferred embodiment of the invention, the step of exchanging substrate ions also comprises the step of heating the substrate, in order to increase the mobility of the ions and thereby to accelerate the exchange process.

Moreover, in a simple way the coating of the at least one first region of the substrate with a coating comprising the first layer can be effected by photolithographic patterning of the coating. It may also be advantageous for the step of removing substrate material from at least one region that adjoins the first region to comprise the step of photolithographic patterning of the substrate.

According to a particularly preferred embodiment of the invention, the production of a coated first region of the substrate and the removal of substrate material from a second region is carried out by

a photoresist layer being applied to the substrate which has been provided with a coating,

the photoresist layer being positively patterned by exposure and developing, so that the photoresist layer is removed above the at least one second region that adjoins the first region,

the coating comprising a first layer being removed on the at least one second region, and then

substrate material being removed from this region.

In particular wet-chemical and/or dry-chemical etching (RIE, CAIBE) of the coating and/or ion beam etching (IBE) are suitable for removing the coating from the second region. It is also possible for the substrate material to be removed from the second region by wet-chemical and/or dry-chemical etching.

Furthermore, according to a particularly preferred embodiment of the process according to the invention, the step of exchanging substrate ions with exchange ions from the first layer comprises the step of field-assisted exchange of substrate ions with exchange ions from the first layer. The field assistance results in even better definition of the refractive index profile and/or of the interfaces of an optical element produced in accordance with the invention. In particular, in the region of the elevated first region the electric field runs substantially perpendicular to the surface, whereas at the height of the surface of the recessed second region, or at the base of the raised structure of the first region, the electric field fans out extensively. This also leads to extensive dilution of the exchange ions at this location, with the result that the drop in concentration of exchange ions which occurs as a result produces a relatively sharp change in the refractive index.

For the exchange processes, it has proven particularly expedient for the first layer to be applied with a thickness in a range from 20 nm to 1200 nm, preferably in a range from 100 to 600 nm. Furthermore, a particularly suitable first layer is a silver layer, since silver ions cause relatively high changes in refractive index if they replace sodium ions, for example.

To effect a field-assisted ion exchange, it is advantageously possible for a voltage to be applied between the coating and an electrode layer on an opposite side from the side bearing the coating comprising the first layer.

To provide an electrode layer of this type, the process, provided for example that the substrate does not already have a conductive surface on one side, may advantageously also comprise the step of applying an electrode layer to an opposite side from the coating comprising the first layer.

Moreover, it may be advantageous for the coating applied to the first region of the substrate not to be just a single layer. Rather, in addition to the first layer, it is also possible for a second or further layers to be deposited or applied. In this context, in particular in the case of field-assisted ion exchange it is expedient if at least one layer of the coating is conductive. Of course, this applies even if the coating comprises just a single layer.

By way of example, it is advantageous if at least a second layer is also present during field-assisted ion exchange. This ensures that the voltage supply is maintained even when the layer is diluted by the exchange atoms as a result of the exchange process, ultimately losing its conductivity.

In this case, it is preferable for the second layer to be applied to the first layer, so that the first layer is in direct contact with the substrate and the exchange atoms can pass into the substrate without disruption. A suitable second layer includes, inter alia, a layer which comprises titanium or copper.

A suitable process for applying the coating to the first region of the substrate is, for example, PVD coating, i.e. physical vapor deposition or sputtering. In this case, it is possible for both the first layer comprising the exchange atoms and also, if provided, the further layers, in particular the second layer, to be deposited by means of PVD coating or sputtering. It is also advantageous for an electrode layer to be deposited on the opposite side by means of PVD or sputtering.

After the ion exchange has been carried out and in this way an optical element has been defined in the substrate, the remaining coating on the first side of the substrate can finally be removed. It is also possible for the electrode layer on the opposite second side to be removed by suitable processes after field-assisted ion exchange.

The at least one second region, which has been recessed with respect to the first region by removal of substrate material, can also then be filled again. It is also possible, for example in order to protect the structures produced on the substrate and to optimize the optical mode field, for the substrate to be covered, in particular on a side having an optical element which has been produced in accordance with the invention, by coating with a transparent material after the ion exchange.

An optical device producible in accordance with the invention may, of course, also in particular, have a multiplicity of raised sections with exchanged ions, so that a large number of integrated optical devices can be realized. Examples of optical devices which can be realized on a substrate by optical elements produced in accordance with the invention include:

Mach-Zehnder interferometers,

thermo-optical and electro-optical switches,

arrayed waveguide gratings (AWG),

optical multiplexers or demultiplexers, or splitters.

In particular, optical amplifier elements are also of interest for integrated optical applications.

Other optical elements, such as for example a Grin lens or a diffractive optical element, can also be produced in accordance with the invention. A further application area includes computer-generated holograms.

According to a preferred embodiment, the substrate comprises a glass. Glasses which are suitable for the production of optical devices include, inter alia, silicate, borate, germanate, arsenic oxide and phosphate glasses. LiNbO glasses are also a suitable substrate material in particular for active optical devices.

To produce optically amplifying elements, the substrate may particularly advantageously also comprise an optically amplifying material. In this respect, a suitable optically amplifying material is a rare-earth-doped material, in particular an erbium- and ytterbium-doped material.

### BRIEF DESCRIPTION OF THE SEVERAL VIEWS OF THE DRAWINGS

The invention is explained in more detail below on the basis of preferred embodiments and with reference to the appended figures, in which identical reference symbols also denote identical or similar parts. In the drawing:

FIG. 1A to FIG. 1F use schematic cross-sectional views to illustrate the process steps involved in carrying out the process according to the invention,

FIGS. 2A and 2B show a variant of the process steps shown with reference to FIG. 1A to 1D,

FIGS. 3A and 3B show optical devices produced in accordance with the invention after a further process step has been carried out in accordance with yet another embodiment of the process according to the invention,

FIG. 4 shows the field distribution within the substrate with field-assisted ion exchange,

FIG. 5A to 5C show the profile of the concentration of exchange ions in the substrate during the exchange process, and

FIG. 6A to 6D show various embodiments of optical devices producible by means of the process according to the invention.

### DETAILED DESCRIPTION OF THE INVENTION

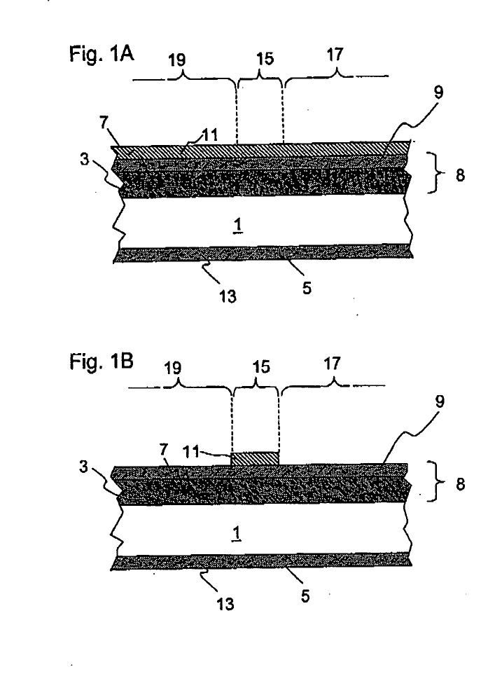

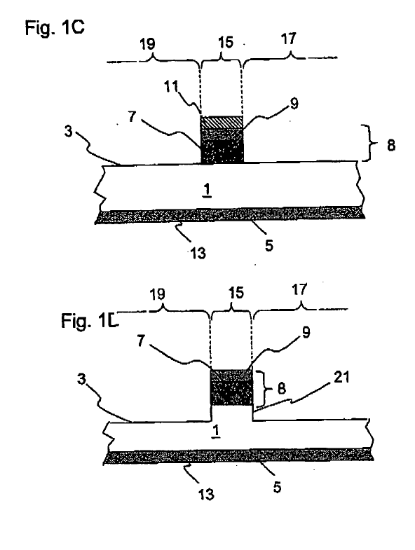

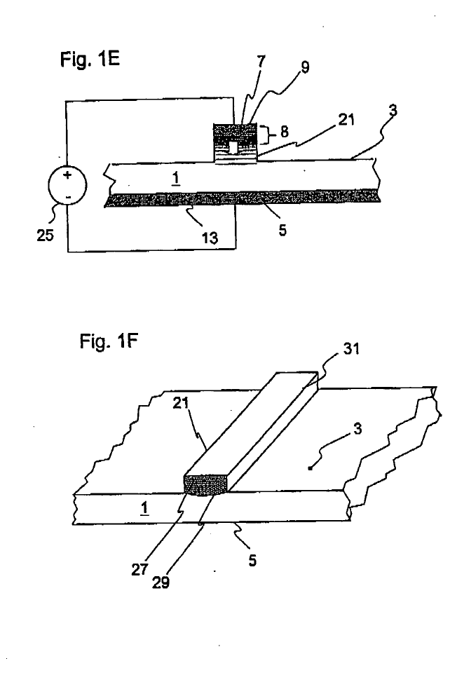

FIG. 1A to 1F use schematic cross-sectional views to show the steps involved in one embodiment of the process according to the invention for producing an optical device according to the invention.

First of all, a substrate 1 is provided with a coating 8 on a first side 3. This coating comprises a first layer 7, which includes exchange atoms in neutral or ionic form. The layer 7 may in this case, by way of example, be a metallic silver layer. It is preferable for the first layer to be applied with a thickness in a range from 20 nm to 1200 nm, preferably in a range from 100 to 600 nm.

The coating 8 also comprises a second layer 9, which is applied to the first layer 7, so that the first layer 7 is in contact with the surface of the substrate 1. The second layer 9 applied may, for example, be a titanium layer, a chromium layer, an aluminum layer or a copper layer. According to a preferred embodiment of the process, the coating 8 comprising the individual layers 7 and 9 is deposited by means of physical vapor deposition. In this case, it is preferable for at least one of the layers 7, 9 of the coating 8 to be conductive.

Moreover, an electrode layer 13 is deposited on the opposite side 5 of the substrate 1. This layer too is preferably produced on the substrate 1 by means of physical vapor deposition or sputtering.

The coating 8 and the substrate 1 are then photolithographically patterned. For this purpose, after the substrate 1 has been coated in the manner described above, a photoresist layer 11 is additionally applied to the coating 8.

Then, the photoresist can be exposed in patterned form by a suitable process, for example, by the exposure being performed through a patterned mask. In this way, at least one first region 15 and adjoining regions 17 and 19 are defined on the first side of the substrate.

In a subsequent step, the photoresist layer 11 is developed, so that the photoresist layer 11 is removed above the second regions 17, 19 that adjoin the first region, whereas it remains in place on the first region 15. FIG. 1B shows the processing state achieved in this way.

Then, the coating 8 is removed from the second regions 17, 19, by wet-chemical and/or dry-chemical etching, as illustrated with reference to FIG. 1C.

As a further step, substrate material is removed from the second regions 17, 19 that adjoin the first region 15, so that a section 21 which is elevated with respect to the adjacent regions 17, 19 and is covered by the coating 8 is formed in the region 15. For this purpose, it is preferable to remove substrate material with a thickness in the range from 0.2 μm to 50 μm, particularly preferably in the range from 1 μm to 15 μm. Finally, the photoresist remaining on the first region 15 can be removed.

With the processing state shown in FIG. 1C, the step of coating at least one first region 15 of the substrate 1 with a coating 8 comprising a first layer 7 which includes exchange atoms in neutral or ionic form is complete.

The process steps which have been shown with reference to FIG. 1C and 1D can also be carried out in a single step, for example if a suitable etchant is used, which can etch both the coating 8 and the substrate material. As an alternative or in addition to wet-chemical or dry-chemical (RIE, CAIBE) etching, the coating 8 and the substrate material can also be removed by ion beam etching (IBE). In this case, by way of example, the coating and the substrate material beneath it can be protected by the photoresist layer 11 in the first region 15.

Therefore, the photolithographic patterning of the coating 8 and the patterning of the substrate are concluded by photolithographic removal of substrate material from the second regions 17, 19. FIG. 1D shows this processing state.

Then, in the substrate which has been prepared in this way, as shown in FIG. 1E substrate ions can be exchanged with exchange ions from the first layer.

The ion exchange in accordance with FIG. 1E is field-assisted. For this purpose, a voltage source 25 is connected to the electrically conductive layer 9 and the likewise electrically conductive electrode layer on the opposite side 5, with the polarity of the voltage source being such that the electrode layer 13 forms the cathode. To increase the mobility of the ions in the substrate 1, the substrate may moreover advantageously be heated. The field-assisted diffusion then causes exchange atoms to migrate out of the first layer 7 as exchange ions into the elevated section 21 of the substrate 1, while at the same time ions of the substrate migrate toward the cathode.

The ion exchange process causes the first layer 7 to break down. This may ultimately even be broken down completely over the course of the exchange process, depending on the layer thickness and the duration of the ion exchange. However, the presence of the second layer 9 prevents the coating 8 from being completely broken down or losing its conductivity on account of its decreasing thickness.

Finally, after the exchange step shown in FIG. 1E, the remaining coating 8 on the first side 3 of the substrate 1 can be removed. One embodiment of a patterned substrate 1 obtained in this way is illustrated in FIG. 1F as a cut-open, perspective view. As a result of the ion exchange, a region 27 with at least partially exchanged ions which has a different refractive index than adjacent regions is formed in the substrate 1. This region is delimited by the outer sides of the elevated section 21, on the one hand, and by an interface 29 with adjacent regions within the substrate 1, on the other hand. The interface 29 is not a sharp interface, as is formed, for example, at the surface of a solid, transparent material with respect to the environment, but rather, on account of the concentration of exchange ions decreasing toward adjacent substrate regions, is diffuse. However, on the other hand, in the ion exchange carried out in accordance with the invention the interface 29 created is significantly sharper than in known processes, since the concentration of the exchange ions drops sharply in the region of the interface created in accordance with the invention, on account of the field distribution in the ion exchange. For example, if Na⁺ ions have been exchanged for Ag⁺ ions, the region 27 has a higher refractive index than adjoining regions, so that light can be guided in the elevated section 21.

In the embodiment shown in FIG. 1F, the first region 15 was originally elongate in form along the surface of the first side 3 of the substrate 1, so that after the process had been carried out the elevated section 21 also takes this shape, with the result that the elevated section 21 together with the interface 29 forms a waveguide 31.

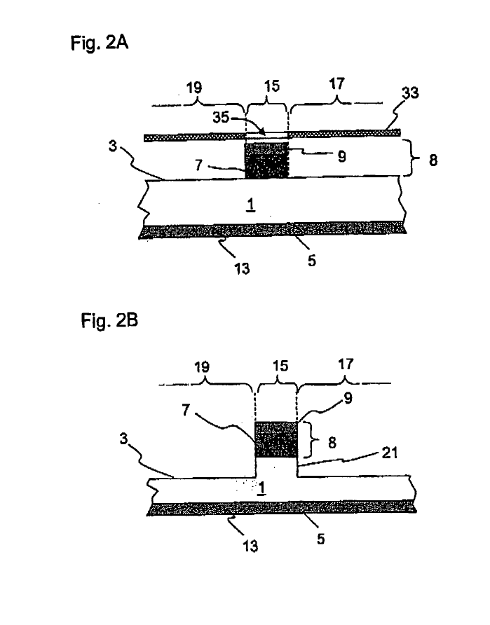

FIGS. 2A and 2C show a variant of the process steps illustrated with reference to FIGS. 1A to 1D.

According to this variant, an electrode layer 13 is likewise applied to the second side 5. The step of coating a first region 15 of the substrate 1 with the coating 8 comprising a first layer 7 which includes exchange atoms in neutral or ionic form and also the second, conductive layer 9 is carried out, according to this variant, not by photolithographic patterning of a layer 8 applied to the entire surface, but rather by evaporation coating of the layers 7 and 9 through a mask 33 with a suitably patterned opening 35.

Using a suitable etchant, which attacks the substrate but substantially does not attack the layers 7, 9 of the coating 8, or by ion etching, substrate material is then removed from the regions 17 and 19 that adjoin the first, coated region 15, resulting in the processing state shown in FIG. 2B, which is similar to the configuration shown in FIG. 1D.

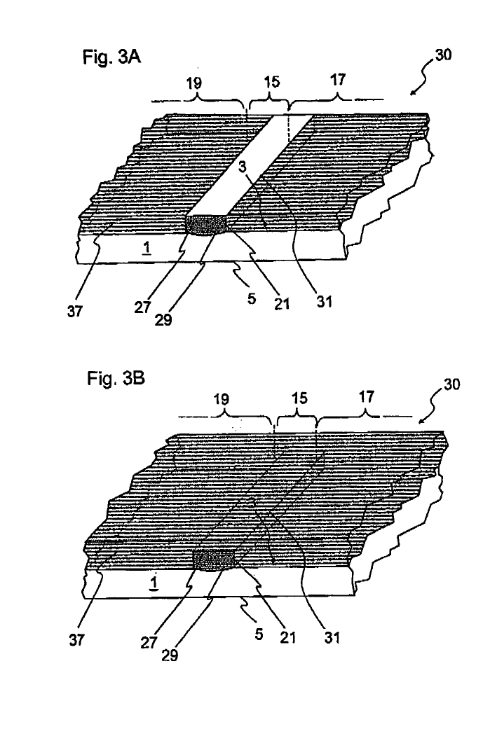

FIG. 3A and 3B show optical devices produced in accordance with the invention after an additional process step in accordance with a further embodiment of the process according to the invention has been carried out. For this purpose, the substrates are prepared in accordance with the process steps shown in FIG. 1A to 1F, although it is also possible, by way of example, for the process steps in accordance with the above description of FIGS. 2A and 2B to be carried out instead of the process steps shown in FIG. 1A to 1D.

Then, the elevated section of the first side 3, or the optical element formed therefrom, is coated with a transparent material, such as, for example SiO₂ or a polymer. The embodiment shown in FIG. 3A was coated in such a way that the substrate material removed from the second regions 17, 19 is filled up again. As a result, the outer side of the elevated section 21 remains uncovered. This embodiment of an optical device produced in accordance with the invention and denoted overall by 30 may also subsequently be provided, for example, with a further coating. The uncovered outer side can also be used for introduction or discharging of light. Furthermore, further optical elements can be applied using other processes and can in this way come into contact with the elevated section 21, which is designed, by way of example, as a waveguide 31.

FIG. 3B shows an optical device 30 having a substrate 1 which has likewise been coated with a transparent material 37 on the first side 3.

In this embodiment of the invention, however, the first side 3 was coated in such a way that the elevated section 21 is completely covered. In this way, an optical element of the optical device 30 which is defined by the section 21 and the region 27 with the exchanged ions is well protected from mechanical damage or chemical attack and the optical mode field is optimized. An example of a suitable transparent material in both embodiments is epoxy resin.

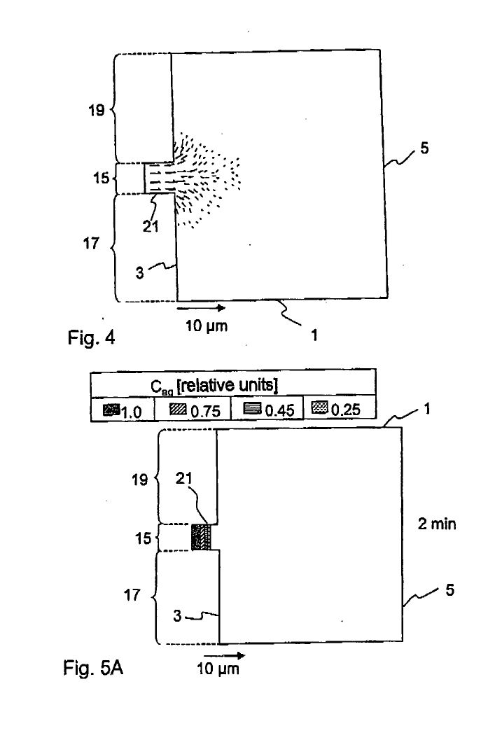

FIG. 4 shows the calculated field distribution of the dielectric shift within a substrate 1. The field is characterized by arrows and dashes within the substrate 1, with the length of the arrows and dashes indicating the field strength. The substrate 1 has been prepared and connected to a voltage source as illustrated in FIG. 1E. For the sake of clarity, however, the coating on the first region 15 and the electrode layer on the side 5 of the substrate are not included in the drawing.

It will be clear from FIG. 4 that the process according to the invention makes it possible to produce significantly more well defined interfaces in the substrate by ion exchange. In the substrate, the field strength decreases rapidly outside the elevated section 21. The result of this is that here there is scarcely any further driving force for the exchange ions which have migrated through the elevated section 21, and consequently the migration process in the substrate substantially ends here.

In this respect, FIG. 5A to 5C show a simulation of the profile of the concentration of exchange ions in the substrate 1 during the exchange process. The exchange layer used in this case is a silver layer. The concentrations are given in relative units based on the highest exchange ion concentration reached. In detail, FIGS. 5A, 5B and 5C show the concentration profile after a process time of 2, 3 and 5 minutes. The different ion concentrations are revealed by differently hatched regions. After a process time of 3 minutes, the exchange ions have reached the bottom of the protruding section 21. After a process time of 5 minutes (FIG. 5C), the first layer containing the exchange ions with the layer thickness used has already been consumed, and consequently the concentration of exchange ions in the section 21 has dropped with respect to the highest concentration which was present at the start of the exchange process. On account of the field distribution at the base of the section 21, the concentration of the exchange ions decreases greatly, as has been explained above, with the result that after a process time of 5 minutes after the end of the exchange process a relatively well-defined interface with adjacent regions of the substrate 1 has formed.

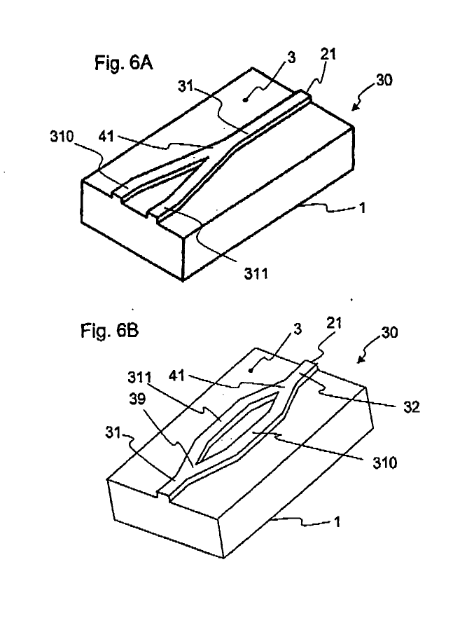

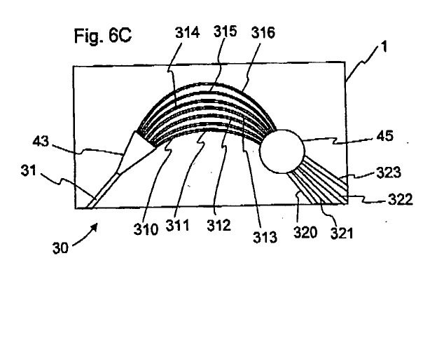

The following text refers to FIG. 6A to 6D, which show various exemplary embodiments of optical devices which can be produced by the process according to the invention.

FIG. 6A shows an optical device 30 which comprises an optical splitter. For this purpose, the device has a waveguide 31 which is formed from an elevated section 21 and is split into two further waveguides 310, 311 at a branching location 41.

FIG. 6B shows a further embodiment of an optical device 30 according to the invention which includes a Mach-Zehnder interferometer. The latter comprises two waveguides 31, 32, which are connected to one another via branching locations 39, 41 and waveguides 310, 311 connected thereto.

FIG. 6C shows an embodiment of an optical device according to the invention with an arrayed waveguide grating. The latter comprises a waveguide 31 which is adjoined by a first free-beam region 43, further waveguides 310 to 316 connected to the first free-beam region 43 and a further free-beam region 45, and waveguides 320 to 323 connected to the further free-beam region 45.

The waveguides 310 to 316 are of different lengths in order to generate phase shifts between the part-beams passing through the waveguides. The substrate may also comprise an optically amplifying material, such as, for example, a suitable erbium-doped glass, so that additional amplifier structures for amplifying the part-beams passing through the waveguides 320 to 323 can be integrated in the optical device 30. All the structures 31, 43, 45, 310 to 316, 320 to 323 shown in FIG. 6C can advantageously be produced using the process according to the invention and accordingly may comprise sections which are elevated with respect to adjacent regions of the substrate 1 and define the respective optical structures.

1. A process for producing an optical device by means of ion exchange, comprising:
coating at least one first region of a substrate with a coating having a first layer that includes exchange atoms in neutral or ionic form;
removing a portion of said substrate from at least one second region that adjoins said at least one first region; and
exchanging substrate ions with exchange ions from said first layer.

2. The process as claimed in claim 1, wherein exchanging said substrate ions comprises heating said substrate.

3. The process as claimed in claim 1, wherein coating said at least one first region comprises photolithographic patterning of said coating on said substrate.

4. The process as claimed in claim 1, wherein removing said portion of said substrate comprises photolithographic patterning or screen printing.

5. The process as claimed in claim 1, further comprising applying said coating to said at least one second region.

6. The process as claimed in claim 5, wherein removing said coating from said at least one second region comprises wet-chemical etching, dry-chemical etching, ion beam etching, and any combinations thereof.

7. The process as claimed in claim 1, wherein removing said portion of said substrate comprises wet-chemical etching, dry-chemical etching, ion beam etching, and any combinations thereof.

8. The process as claimed in claim 1, wherein exchanging said substrate ions with said exchange ions comprises field-assisted exchange of said substrate ions with said exchange ions.

9. The process as claimed in claim 8, further comprising applying an electrode layer to a side of said substrate opposite said coating.

10. The process as claimed in claim 9, wherein said electrode layer is deposited by means of physical vapor deposition or sputtering.

11. The process as claimed in claim 9, wherein said field-assisted exchange comprises applying a voltage between said coating and said electrode layer.

12. The process as claimed in claim 1, wherein said first layer is applied with a thickness in a range from 20 nm to 1200 nm.

13. The process as claimed in claim 1, wherein said first layer is applied with a thickness in a range from 100 nm to 600 nm.

14. The process as claimed in claim 1, wherein said coating comprises a silver layer.

15. The process as claimed in claim 1, further comprising applying a second layer to said at least one first region.

16. The process as claimed in claim 15, wherein said second layer is applied to said first layer.

17. The process as claimed in claim 15, wherein said second layer comprises a material selected from the group consisting of titanium, chromium, aluminum, and copper.

18. The process as claimed in claim 15, wherein at least one of said first and second layers is conductive.

19. The process as claimed in claim 1, wherein said coating is deposited by means of physical vapor deposition.

20. The process as claimed in claim 1, wherein removing said portion of said substrate comprises removing of substrate material to a thickness in the range from 0.2 μm to 50 μm.

21. The process as claimed in claim 1, wherein removing said portion of said substrate comprises removing of substrate material to a thickness in the range from 1 μm to 15 μm.

22. The process as claimed in claim 1, further comprising removing any remaining portions of said coating after exchanging said substrate ions with said exchange ions.

23. The process as claimed in claim 1, further comprising coating said substrate with a transparent material after exchanging said substrate ions with said exchange ions

24. The process as claimed in claim 23, wherein said transparent material comprises SiO₂ or a polymer.

25. An optical device comprising:
a substrate;
at least one first region on one side of said substrate; and
at least one second region that adjoins said at least one first region, said at least one first region being elevated with respect to said at least one second region so that said substrate has a protruding section in said at least one first region, wherein ions of said substrate are at least partially exchanged in the protruding section.

26. The optical device as claimed in claim 25, wherein said protruding section has a refractive index that is higher than the refractive index of adjacent sections of said substrate.

27. The optical device as claimed in claim 25, wherein said protruding section comprises at least one waveguide.

28. The optical device as claimed in claim 25, wherein the optical device comprises an element selected from the group consisting of a Mach-Zehnder interferometer, a thermo-optical or electro-optical switch, an arrayed waveguide grating (AWG), an optical multiplexer or demultiplexer, a splitter, an optical directional coupler, a Grin lens, a diffractive optical element, a computer-generated hologram, and an optical amplifier.

29. The optical device as claimed in claim 25, wherein said substrate comprises a glass.

30. The optical device as claimed in claim 29, wherein said glass is selected from the group consisting of silicate glass, borate glass, germanate glass, arsenic oxide glass, phosphate glass, and LiNbO glass.

31. The optical device as claimed in claim 25, wherein said substrate comprises an optically amplifying material.

32. The optical device as claimed in claim 31, wherein said substrate comprises a rare-earth-doped material.

33. The optical device as claimed in claim 32, wherein said rare-earth-doped material comprises an erbium-doped material or a ytterbium-doped material.
